(19) United States
(12) Patent Application Publication
(10) Pub. No.: US 2018/0160843 A1
(43) Pub. Date: Jun. 14, 2018

(54) Fold- and Pour-over Device and Method for Straining

(71) Applicant: Mary Kristin Swift, Farmington, UT (US)

(72) Inventor: Mary Kristin Swift, Farmington, UT (US)

(21) Appl. No.: 15/376,367

(22) Filed: Dec. 12, 2016

(51) Int. Cl. A47J 31/20; A47J 31/06; A23F 3/18

(52) U.S. Cl. CPC A47J 31/20; A23F 3/18; A47J 31/0615

(57) ABSTRACT

The disclosed invention is a fold- and pour-over device and method for straining comprised of a perforated disc (main body possibly with a handle) that splays out into a plurality of fold-over sections pivotally connected at an interfacing center and separated by section indicators intended to overlap when the straining device is depressed into and below the rim of a holding unit atop straining material, pre-filled in the holding unit, and upon release expands out to secure to the inside diameter of the holding unit at which time liquid, either pre-heated or to be microwaved, can be poured into the holding unit and over the top of the straining device to enter and exit through the perforations and mix with the straining material as the straining device remains securely in place through multiple refills of hot water to restrain the same material until fully expended.

### CROSS-REFERENCE TO RELATED APPLICATIONS

Not applicable.

### STATEMENT REGARDING FEDERALLY SPONSORED RESEARCH OR DEVELOPMENT

Not applicable.

### REFERENCE TO SEQUENCE LISTING

Not applicable.

### FIELD OF THE INVENTION

The invention is in the technical field of straining. More particularly, the invention is in the technical field of beverage straining. More particularly, the invention is in the technical field of tea straining for the purpose of brewing loose tea leaves, herbs and other beverage material.

### BACKGROUND OF THE INVENTION

Tea is consumed in large quantities on a daily basis throughout the United States and around the world. Tea bags are one popular tea straining method. The drawbacks of the tea bag is that it is usually discarded after one use which can be costly, may contain tea fannings (pieces of stems and other less desirable tea parts), is only available in limited and pre-manufactured flavors, and carries with it a concern about the plastic version of the tea bag, for example, the pyramid-shaped silk-mesh type, leaching chemicals into the tea. Therefore, tea bags may be considered a low quality yet high cost solution for tea brewing.

More recently, “single-serve” (typically around twelve ounces or less) brew beverage apparatus have become common. This involves a costly beverage apparatus with reusable cartridges. Typically, these apparatus offer the ability to customize a cup of tea but have poor filtering mechanics and can leave unwanted residue in the prepared tea. Also, reusable cartridges are difficult to clean, apparatus specific, not easy to use, and are not portable. Therefore, a single-serve apparatus may not be preferred nor meet the demands of the transient tea drinker.

For the above reasons many tea drinkers prefer brewing tea from loose tea leaves utilizing a tea strainer. Although there are a wide variety of tea straining devices, the same basic method is used which is to strain hot water from loose tea leaves that are compacted into a perforated receptacle (sometimes multi-part) which is formed as a basket, spoon, whisk, or ball, for example, and is typically comprised of a handle that extends out of the cup. The tea strainer is usually removed from the cup after steeping as it gets in the way of tea drinking and ends up being placed in and out of the cup (which requires a dish or amenities nearby) for additional fill-ups of hot water to restrain the tea leaves multiple times until they have been fully expended.

Drawbacks of the conventional tea straining method are that it is messy and cumbersome to fill the receptacle as well as to remove the tea strainer from the cup between each use.

Drawbacks of conventional tea straining devices are that they are limited in the amount of straining material that can be packed into the receptacle, the multi-part receptacles may require delicate handling to avoid breakage, the materials such as plastic, stainless steel or even bamboo fibers are configured with edges and crevasses that are difficult to clean, and the visually appealing strainers can possess awkward shapes that take up extra storage space, contributing to clutter.

Therefore, the fold- and pour-over device and method for straining will be further disclosed for more detail as to the attributes which can contribute to the field of tea straining, beverage straining, or any other fields of use where the claimed method and device would prove valuable.

### SUMMARY OF THE INVENTION

The invention is a fold- and pour-over device and method for straining comprised of a perforated disc (main body) that folds into a holding unit, a cup or carafe for example, and is placed below the rim atop straining material, pre-filled into the holding unit, at which time hot water can be poured in the holding unit and over the straining device to enter and exit through the perforations and mix with the straining material. Furthermore, this same straining device does not comprise a receptacle to be filled, is not limited to the amount of straining material that can be utilized, and is not intended to be removed during the straining process so that it remains securely in place through multiple refills of hot water to restrain the same material until fully expended.

### BRIEF DESCRIPTION OF THE DRAWINGS

FIG. 1 is a top, side and bottom view of the invention in a preferred embodiment (with an indication of some type of handle) as a tea strainer;

FIG. 2 is a perspective view of the invention placed in a cup (shown in broken lines).

The broken lines shown in the perspective view are for the purpose of illustrating structure and thus, form no part of the claimed design.

It should be noted that the drawings are presented for the purpose of illustration and not intended to limit the disclosure to any or all of the exact details of construction and manufacture shown or described herein, except insofar as they may be deemed essential to the claimed invention.

### DETAILED DESCRIPTION OF THE INVENTION

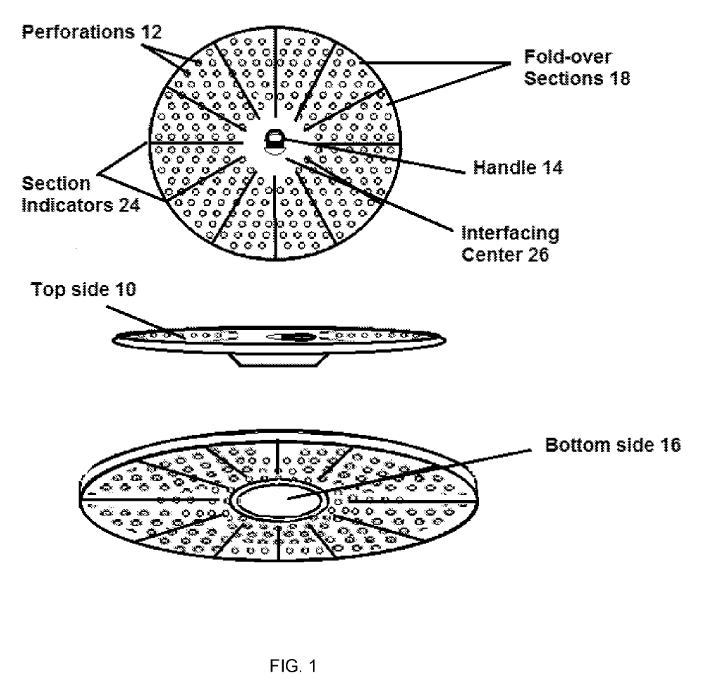

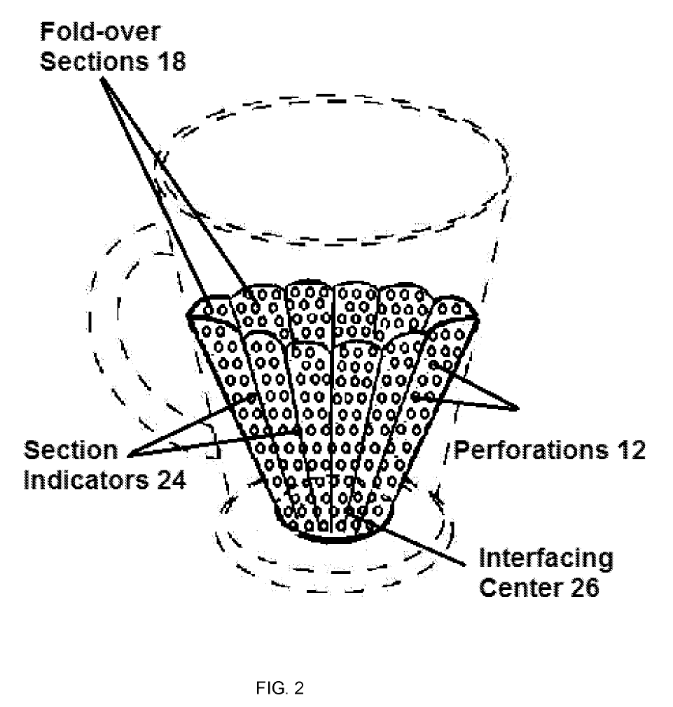

The details and orientation of the invention are referenced in FIG. 1 and FIG. 2 and will be commonly referred to as a preferred embodiment of a tea strainer. Furthermore, the invention may have additional embodiments, may be practiced without one or more of the details described for any particularly described embodiment, or may have any detail described for one particular embodiment practiced with any other detail described for another embodiment.

The tea strainer is comprised of a perforated disc, referred to herein as the main body, which encompasses an interfacing center 26, fold-over sections 18, section indicators 24, a top side 10, a bottom side 16, perforations 12, a handle 14, and any other parts, thereof.

FIG. 1 and FIG. 2 show a preferred embodiment of a tea strainer comprised of an interfacing center 26 with one handle 14 monolithically formed and distal to the top side 10 that extrudes at the bottom side 16. From the interfacing center 26 the main body splays out into a plurality of fold-over sections 18 separated by section indicators 24 (twelve are illustrated). The fold-over sections 18 overlap when depressed into the cup, pre-filled with tea leaves (not shown), and when the tea strainer is released below the rim it expands out to secure to the inside diameter of the cup at which time water, either pre-heated or to be heated, can be poured into the cup and over the tea strainer to enter and exit through the perforations 12 and mix with the straining material while the tea strainer remains in place through multiple refills of hot water until the tea leaves have been fully expended.

The geometries suitable for constructing the main body do not require a quantity of one handle 14 or twelve fold-over sections 18 and section indicators 24 as illustrated in FIG. 1 and FIG. 2. The invention may feature no handle 14, may have more or less fold-over sections 18 and section indicators 24 than illustrated, and may vary in response to changes in the main body or from product to product. Furthermore, the main body is intended to allow for adjustments in diameter so long as the overall basic shape and function of the invention are not compromised.

The geometries suitable for constructing the interfacing center 26 of the main body are also intended to allow for adjustments in diameter so long as the overall basic shape and function of the invention are not compromised. Furthermore, the diameter may be altered to adapt to changes made to the main body or any other parts, thereof.

The geometries suitable for constructing the fold-over sections 18 of the main body may comprise any suitable diameter(s) that allows for the intended overlaps to occur along section indicators 24 and can vary in number, length or width and may possess a variety of patterns and features such as ridges, bumps, designs, or advertisements which can differ from the top side 10 to the bottom side 16 and from product to product.

The geometries suitable for constructing section indicators 24 of the main body serve not only as visible indicators of where the fold-over sections 18 should overlap but also as geometrical features increasing the probability that an overlap will occur precisely at those locations where the section indicators 24 separate the fold-over sections 18 from the interfacing center 26. Section indicators 24 may be constructed as a slit, line, fold or pleat that is formed as a cut, score, perforation, indentation, or any other combination, thereof. Furthermore, the section indicators 24 may vary in number, length and width as needed or as necessary to remain adaptable to changes in the main body or any parts, thereof.

The geometries suitable for constructing a handle 14 of a preferred embodiment of the main body may be monolithically formed and distal to the top side 10 of the interfacing center 26 and can extrude out, be hollow or any other configuration formed at the interfacing center 26 on the bottom side 16, or may be constructed as a separate part that attaches to the main body. The handle 14 may comprise any suitable material(s) or dimension(s) and can be constructed as solid, flexible, hollow, or any detail described for one particular embodiment practiced with any of details described for another embodiment, or any combination, thereof. Furthermore, the handle 14 may vary in number, length and width as needed or as necessary to remain adaptable to changes in the main body or any parts, thereof.

The geometries suitable for constructing perforations 12 of the main body may comprise any suitable pattern where the size of the pores can be made sufficiently small enough that most of the residue from the loose tea leaves cannot escape through perforations 12 as well as sufficiently large enough that any surface tension formed on the periphery would have a negligible effect on the flow of the hot water through the pores. Furthermore, the perforations 12 may vary in number, pattern, and pore size as needed or as necessary to remain adaptable to changes in the main body or any parts, thereof.

The geometries suitable for constructing the material(s) of the main body and parts, thereof, comprise a long lasting, durable, microwave and dishwasher safe, and able to withstand accurate and repeatable results in the manufacturing process. Furthermore, it has been found that many materials are ideal to achieve these properties but silicone and microwavable cloth may be two preferred materials.

The manufacturing process suitable for constructing the invention lends itself to advancements made in the field of silicone mold manufacturing, as a plethora of silicone items have made their entrance into the market lately and have grown in popularity, promising silicone molding to be a viable consideration. The silicone molding process is not limited to forming only slits, lines, scores, indentations, or perforations or the like but can be used for a wide variety of operations that could include, for example, forming handles or suction cups. Furthermore, the invention is not limited to manufacture only by silicone molding but may be constructed utilizing any suitable manufacturing process.

The fold- and pour-over device and method for straining is intended to be simple to use, collapsible, durable, have greater straining capacity, easy to clean and store, portable, inexpensive, and have the ability to display design(s) or advertisement(s) on the main body without changing the overall basic shape or function of the invention.

While preferred and alternate embodiments have been illustrated and described, as noted above, many changes can be made without departing from the spirit and scope of the invention. Any further embodiments of the invention should be understood by relating to FIG. 1 and FIG. 2. Accordingly, the scope of the invention is not limited by the disclosure of these details and embodiments. Instead, the scope of the invention should be determined by reference to the claims that follow.

What is claimed is:

1. A fold- and pour-over device and method for straining wherein a perforated disc, herein referred to as the main body, comprises an interfacing center (possibly with a handle) that splays out into a plurality of fold-over sections separated by section indicators which overlap when the straining device is depressed into and below the rim of the holding unit, atop straining material that has been pre-filled in the holding unit, and upon release is intended to expand out and secure to the inside diameter of the holding unit at which time liquid, either pre-heated or to be microwaved, can be poured into the holding unit and over the straining device to enter and exit through the perforations and mix with the straining material while the straining device remains in place through multiple refills of hot water until the same material has been fully expended.

2. The device and method of claim 1, wherein the main body may be comprised of an interfacing center, fold-over section(s), section indicator(s), a top side, a bottom side, a handle and any other parts, thereof.

3. The device and method of claim 2, wherein parts of the main body comprise any suitable number, diameter, length, width or dimensions necessary to adapt to various sized and shaped holding units as long as the basic shape and function of the invention are not compromised.

4. The device and method of claim 2, wherein the main body is axially movable (foldable) so that when in a non-inverted position, remains relatively flat and when inverted will appear relatively cone-shaped via the overlapping fold-over sections separated by section indicators that pivotally extend from the interfacing center.

5. The device and method of claim 2, wherein the perforations of the main body comprise a plurality of pores of a non-specific number, size, shape or pattern that are small enough to retain most of the straining material below and large enough to allow liquid to enter and exit through the pores in order to mix with the straining material.

6. The device and method of claim 2, wherein the top and bottom sides of the main body can comprise different features or patterns such as color, ridges, bumps, advertisement(s), design(s), or any other combinations, thereof. Furthermore the top and bottom sides may comprise different functions for the same feature, for example, the top side may have a handle wherein the bottom side only exhibits minimal extrusion or may be hollow. Another example might be a suction cup molded into the fold-over section(s) to assist the straining device to remain in place when in use, wherein the top side of the suction cup would have an entirely different function than the bottom side.

7. The device and method of claim 6, wherein a handle may be formed monolithically and distal to the top side of the interfacing center and which can comprise a variety of shapes, materials, functions, forms, designs, dimensions, or any other combinations, thereof. For example, the handle could lay relatively flat, be hollow, extrude out at the bottom side, be constructed as a separate part that attaches to the main body, made of a different material, be attached in different locations on the interfacing center, or any other combinations or embodiments, thereof.

8. The device and method of claim 1, may be comprised of a material(s) that is flexible, chosen from a group of materials such as silicone or microwavable cloth that are not only microwave and dishwasher safe but durable enough to withstand accurate and repeatable results in the manufacturing process. The thickness (or any other measure) may vary, for example if made from silicone, the durometer may differ across the main body, from one part to another, from product to product, or in response to adaptations to the main body for flexibility, function, strength, fit or any other combination(s), thereof.

9. The device and method of claim 1, may be manufactured via mold, extrusion, sewn or use any combination(s) of materials for manufacture such as silicone, plastic, stainless steel, microwavable cloth or any other material(s) or manufacturing process, or combination(s), thereof. Furthermore, the invention is not limited to manufacture only by silicone molding but may be constructed utilizing any suitable manufacturing process.
